(19) United States
(12) Patent Application Publication
(10) Pub. No.: US 2014/0067424 A1
(43) Pub. Date: Mar. 6, 2014

(54) AUTOMATED IDENTIFICATION AND DOCUMENTATION OF CO-MORBIDITIES FROM PATIENTS ELECTRONIC HEALTH RECORD IN THE EMERGENCY ROOM

(71) Applicants: I.V. Ramakrishnan, Setauket, NY (US); Mark Henry, Northport, NY (US)

(72) Inventors: I.V. Ramakrishnan, Setauket, NY (US); Mark Henry, Northport, NY (US)

(73) Assignee: The Research Foundation for The State University of New York, Albany, NY (US)

(21) Appl. No.: 14/012,422

(22) Filed: Aug. 28, 2013

Related U.S. Application Data
(60) Provisional application No. 61/693,823, filed on Aug. 28, 2012.

(51) Int. Cl. G06F 19/00

(52) U.S. Cl. CPC G06F 19/322
USPC 705/3

(57) ABSTRACT

An inventive system and method for identifying and documenting co-morbidities is provided. The method can include selecting co-morbidity-related clinical data in accordance with one or more rules, said clinical data selected for a patient from the history data of the patient, pushing the selected clinical data to a display on a display device, displaying the selected clinical data on the display device along with the one or more rules, analyzing the displayed selected clinical data in accordance with the displayed one or more rules, validating the displayed selected data and storing the validated data. In one aspect, the method can further comprise sending the validated data to billing and/or printing the validated data. In one aspect, the clinical data can comprise one or more of laboratory data, EKG data, Echo data and radiology data.

### CROSS REFERENCE TO RELATED APPLICATIONS

The present application claims benefit of U.S. Provisional Application No. 61/693,823, filed Aug. 28, 2012, the entire contents of which are incorporated herein by reference.

### FIELD OF THE INVENTION

The present invention relates generally to electronic health records (“EHR”) and identifying co-morbidities and/or comorbid conditions in electronic health records in the emergency room.

### BACKGROUND OF THE DISCLOSURE

Health Systems across New York State and nationally are focused on moving to electronic health records (EHRs) both in the hospital and ambulatory settings to make patients' clinical information easily retrievable across settings. In addition, the federal government has tied reimbursement for hospitals and physicians to demonstration of meaningful use of EHRs. As the EHR is relatively new and its potential great, there are multiple opportunities to improve the products in current use. Improvements to the EHR that increase the quality of health care provided as well as enhance accurate reimbursement are needed and will find widespread application.

Co-morbidities, or comorbid conditions, are significant medical conditions that impact on a patient's health, and yet are not the principle or primary diagnosis or reason for a patient encounter with medical personnel. Co-morbidities affect patients' healing, survival and length of hospitalization. Knowledge and documentation of co-morbidities is important information for a patient's health team for proper patient treatment. Moreover, proper documentation of co-morbidities is important for hospital coding in analyzing service intensity weight, risk adjusted outcome measures, staffing and reimbursement.

During a patient encounter in the emergency department of a hospital or care center, there is typically an opportunity to document what co-morbidities a patient may have, so that care givers are aware and can address them. Often these co-morbidities, which may be discovered during the encounter, are not the principle reason for the encounter or visit. Thus these co-morbidities are not listed as a diagnosis or reason for visit in the record, even though the co-morbidities may affect the severity of the illness that brought the patient to the emergency department. For accurate coding, reimbursement and data collection purposes, the co-morbidities must be expressed in the narrative description (such as hyperpotassemia when the K+ is 6.5) and signed by the physician. At times, a comorbid condition may be categorized as secondary diagnosis, such as acute respiratory failure when the principle diagnosis is pneumonia.

Electronic health records (EHRs) should improve identification and documentation of pertinent health issues. They should be faster and better than paper records. However, many Computerized Physician Order Entry (CPOE) and EHRs today result in physicians and nurses spending more time at the computer than at the bedside because data collection and entry, not patient care, becomes the focus. With large amounts of data input to the EHR from multiple healthcare practitioners, there is the danger of data overload, resulting in the need to cull through extraneous information to find that which is pertinent. As these data entry tasks take time from the doctor-patient encounter, the tasks are often ignored and/or left incomplete because of time constraints.

Specifically with respect to co-morbidities, extant methods for identifying co-morbidities data in EHRs have relied primarily on costly and time-consuming manual chart review. However, because of the voluminous amount of information which becomes available during ER treatment and the immediate condition being treated by the ER physician, some of the co-morbidities may be missed. Moreover, in certain cases the physician may decide to ignore particular co-morbidities as an unimportant or a transient occurrence.

Thus there is a critical need to develop computing technology to automate proper identification and documentation of co-morbidities in the ER.

### SUMMARY OF THE DISCLOSURE

A novel system and method to automatically identify and document co-morbidities, or comorbid conditions, from patient's EHR is presented. The system can be used within health IT systems to automatically search EHRs and determine comorbid conditions in a timely and accurate manner for review and documentation by physicians. It enhances patient care, more accurately documents patient illness, and assures proper reimbursement.

In one aspect, the method can comprise selecting co-morbidity-related clinical data in accordance with one or more rules, the clinical data selected for a patient from the history data of the patient, pushing the selected clinical data to a display on a user interface, displaying the selected clinical data on the display along with the one or more rules, analyzing the displayed selected clinical data in accordance with the displayed one or more rules, validating the displayed selected data, and storing the validated data as part of the medical records.

In one aspect, the system can comprise a database server storing electronic health records; an application server having a processor; a user interface; and a module operable on the processor, said module operable to select co-morbidity-related clinical data in accordance with one or more rules, the clinical data selected for a patient from the history data of the patient, push the selected clinical data to a display on the user interface, display the selected clinical data on the display along with the one or more rules, analyze the displayed selected clinical data in accordance with the displayed one or more rules, validate the displayed selected data, and store the validated data in the database server.

In one aspect, one or more billable actions related to the validated data can be sent to billing. In one aspect, the clinical data comprises one or more of historical data, laboratory data, EKG data, Echo data and radiology data. In one aspect, the validated data can be printed.

A computer readable storage medium storing a program of instructions executable by a machine to perform one or more methods described herein also may be provided.

### BRIEF DESCRIPTION OF THE DRAWINGS

These and other features, aspects, and advantages of the apparatus of the present invention will become better understood with regard to the following description, appended claims, and accompanying drawings where:

FIG. 1 shows the system architecture for an embodiment of the inventive system.

FIG. 2 is an exemplary display of a clinician's view of a patient's information.

FIG. 3 is an exemplary display of ED checklist of co-morbidity.

FIG. 4 is an exemplary print out of the co-morbidity information and validation.

FIG. 5 is a flow diagram of an embodiment of the inventive method.

### DETAILED DESCRIPTION OF DISCLOSURE

A novel system and method and computer program for identifying and documenting co-morbidities is presented. In one aspect, the innovative technology automatically searches a patient's EHR and extracts co-morbidities (“co-morbidity-related clinical data”) from laboratory values, vital signs monitoring, radiography reports, and other electronic records (such as medication lists), and lists these co-morbidities on a co-morbidity display for review and acknowledgement by the attending physician. The co-morbidities can be current clinical conditions. The inventive system presented herein differs from prior systems in several ways. For example, the novel technology works on EHRs in real-time and is fully automatic. Also, the inventive technology handles a variety of co-morbidities in a general patient population, as opposed to systems that handle only one type of patients, such as cancer patients.

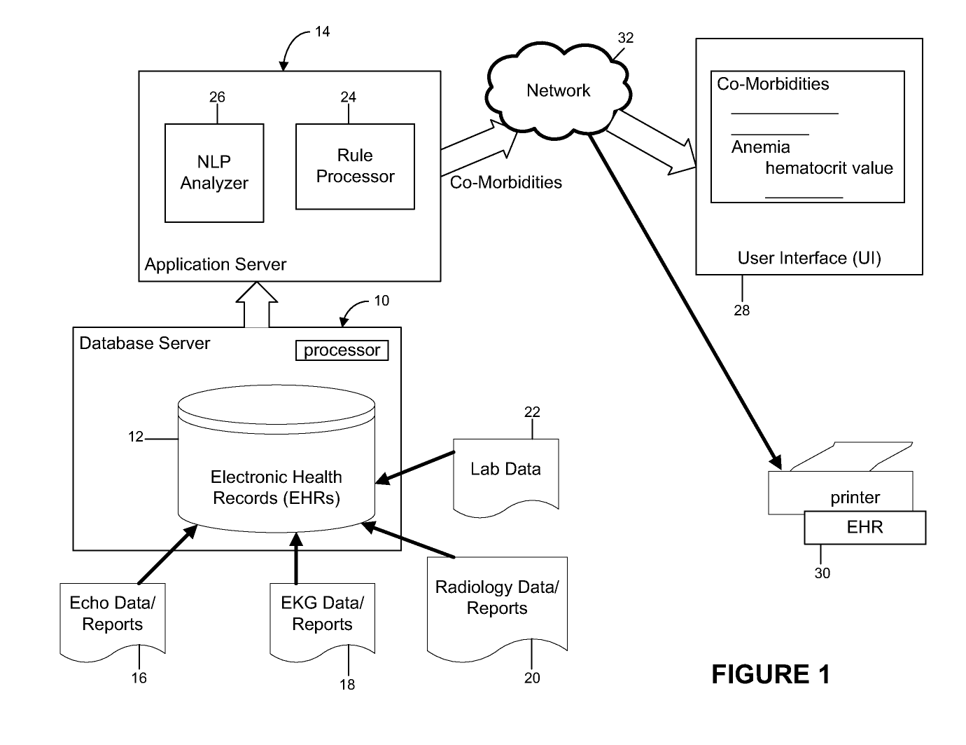

FIG. 1 is a high-level architectural schematic of an embodiment of the inventive system. As shown in FIG. 1, the system has a database server 10 having memory in which patients' EHRs 12 are stored, and an application server 14 having memory in which algorithms for identifying and documenting co-morbidities reside. Each server can include a processor, processing device and/or CPU, storage and memory. End users, such as emergency room clinicians, can interact with the system via a user interface (UI) 28 having a graphical interface or GUI. The results can be displayed by the system on the display of the UI 28 and stored in the EHR and/or printed on a printer 30. The UI 28 can communicate with the database server 10, the application server 14, the EHR and/or printer 30 via a network 32. The network 32 can be a local area network (LAN), intranet, internet, or any other communication network as known to one skilled in the art.

Clinical data about a patient, represented in the patient's EHR 12, can come from several sources depending on the kinds of tests done on the patient—Laboratory (Lab) results 16, Radiology 18, EKG data/reports 20, Echo 22, etc. Selected co-morbidities and/or comorbid conditions are sought which are high priority for the clinicians and/or physicians, and for hospital documentation. Not all clinical data is retrieved. Hence the inventive system displays selected co-morbidities and/or comorbid conditions known to effect severity of illness, treatment, outcome and ambulatory sensitive conditions.

Comorbid conditions are identified by algorithmic analysis of these data. These analyses are encoded as decision making rules. “Alert Fatigue” is avoided by selecting only relevant data, that is, data obtained through analysis in accordance with decision making rules, and displaying and validating only these carefully selected results.

The Rule Processor component 24 executes these decision making rules. Execution of rule(s) associated with co-morbidity corresponds to determining, based on the patient's clinical data, if the co-morbidity holds. The Rule processor can keep physicians up-to-date with ICD-10 and other changes, such as sepsis definitions, so that accurate documentation of important variables is validated and recorded. With respect to the rules required for analysis, end-users of the inventive system can specify the kind of rules they want the system to use for analysis in an intuitive way. For example, one hospital can use RIFLE criteria (Risk, Injury, and Failure; and Loss, and End-stage kidney disease) for determining kidney failure and another can use KDIGO criteria (Kidney Disease; Improving Global Outcomes); the end-user can easily select the rule to be used.

Clinical data in EHR is heterogeneous, i.e., possesses varying formats. Typically, lab data 16 is structured and is represented neatly in tabular form. On the other hand, Radiology and Echo reports 20, 22 are unstructured text. Analysis of such text can be aided by Natural Language Processing technologies such as linguistic parsers, parts of speech taggers, entity extractors, etc., as known to one skilled in the art. All these technologies make up the NLP Anaylzer component 26.

The patient's co-morbidities identified by the algorithm can be presented, e.g., displayed, to the ER clinician via the GUI on the UI 28. The clinician simply needs to validate the displayed co-morbidities. To assist in the validation, the display may also include the rule(s) corresponding to the co-morbidity as well as the associated patient clinical data. For instance, if anemia is identified as a co-morbidity, the GUI 28 will present current hemoglobin/hematocrit values, and past values, if they are available. The GUI 28 will also show the rules for determining anemia based on hemoglobin/hematocrit values. Displaying present and past values quickly assists the clinician in determining whether the anemia is acute or chronic The ER clinician makes the final decision about including or excluding the co-morbidities presented by the algorithm. All of the selected co-morbidities become a part of the patient's EHR.

A use scenario to illustrate the novel invention is presented. A patient comes into the ER complaining of chest pain. The Attending Physician (AP) orders a series of tests. The cardiac tests (EKG and cardiac enzymes) reveal no underlying problems. But the lab tests have identified a couple of other unrelated issues—low potassium and high creatinine. The busy AP wants these findings to be reported to the patient's primary for follow up. The AP clicks on a link labeled co-morbiditites on the ER's IT system. The two abnormal lab findings are displayed. AP clicks on a checkbox validating that these are indeed abnormal and clicks “ok” and the co-morbidities are stored as part of the patient's EHR. The patient is discharged and counseled to see his primary care physician, e.g., “Primary”. In this use scenario, the Primary is a participant in the Regional Health Network and thus has access to his patient's EHR. Upon the patient's discharge from the ER, an email is automatically sent alerting the Primary of the patient's visit to the ER. The email contains a link to the patient's EHR. The patient makes an appointment to follow up with the Primary. When the patient meets the Primary, the Primary opens the email from the ER and clicks on the patient's EHR link. The link to the co-morbidities is displayed prominently in the EHR. On clicking it, the Primary sees a very succinct summary of the co-morbidities and begins to discuss them with the patient.

In this use scenario, the AP responded to the low potassium finding by instructing the nurse to administer supplemental potassium to the patient. In other words, the patient was treated for this condition in the ER—a billable action. For reimbursement purposes, the treated co-morbidity must be documented and named (e.g. hypopotassemia) which, as the use scenario indicates, is intrinsic to the novel system. Thus the system includes the ability to send billable actions related to the validation to billing, e.g., hospital billing department, clinic billing system, etc., as known to one skilled in the art.

In current ER practices, the clinician has to explicitly pull and record the co-morbidities—a time consuming process that is prone to documentation errors and omissions especially in busy ERs. In contrast, the inventive system described herein automatically pushes the co-morbidities to the ER clinician and presents them succinctly in appropriate narrative form. All that the clinician has to do is simply validate them.

The novel system is more sophisticated than straightforward Clinical Decision Support (CDC) systems in that the present system provides information to the physician, and displays the information along with the rule that allows the physician to analyze and verify the displayed data to determine whether or not a comorbid condition is present. Upon verification, the information is documented in the patient's EHS. The inventive system searches multiple fields, e.g., clinical data, within the electronic record with one mouse click and then presents the results to the physician within seconds. For certain co-morbidities, such as anemia or kidney injury, the inventive system also searches past records (prior history) and presents previous and present values to the physicians to help determine whether the condition is chronic or acute.

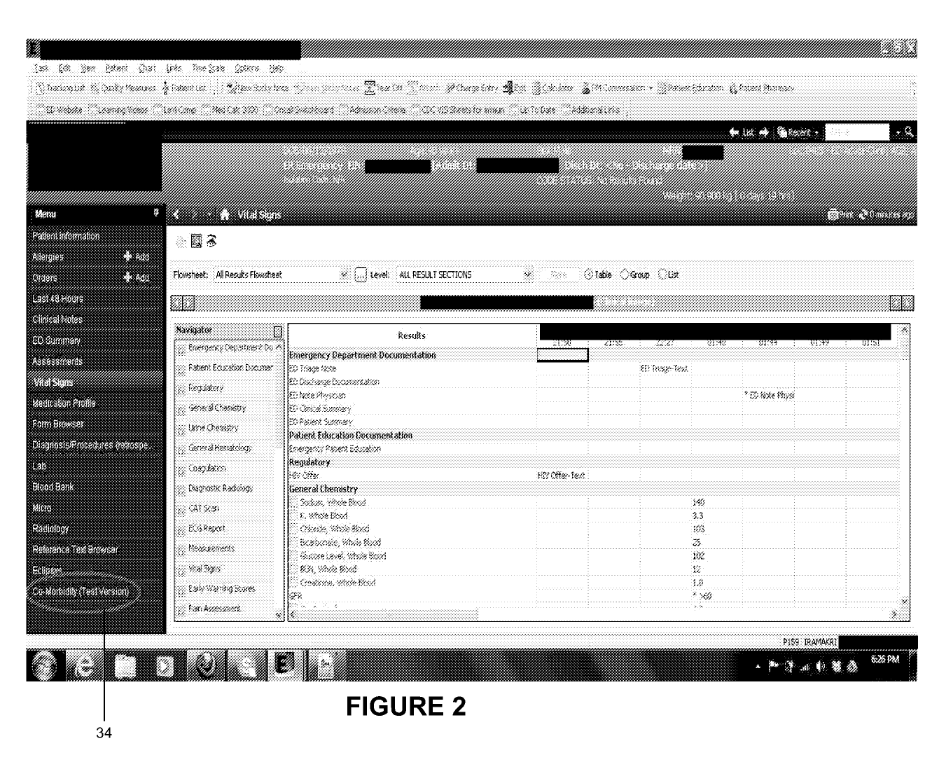

In one embodiment, algorithms (and supporting computing infrastructure) can identify over two dozen co-morbidities from Lab results, vital signs and body weight and height. The algorithms and associated computing infrastructure can be integrated into an Information Technology (IT) system, such as the Cerner IT system at SBU Medical Center's ER. In the Cerner system, the clinician interacts with ER patient's data via a UI 28 which is a browser-centered dashboard. FIG. 2 is a fragmentary snapshot of the clinician's view of a patient's information on this dashboard or UI. To this dashboard a link labeled “co-morbidity” is added; this link is enclosed within the oval 34 in FIG. 2. Upon clicking this link, the co-morbidity application residing on the application server 14 is invoked. The application fetches the patient's EHR from the EHR database 12 system for analysis.

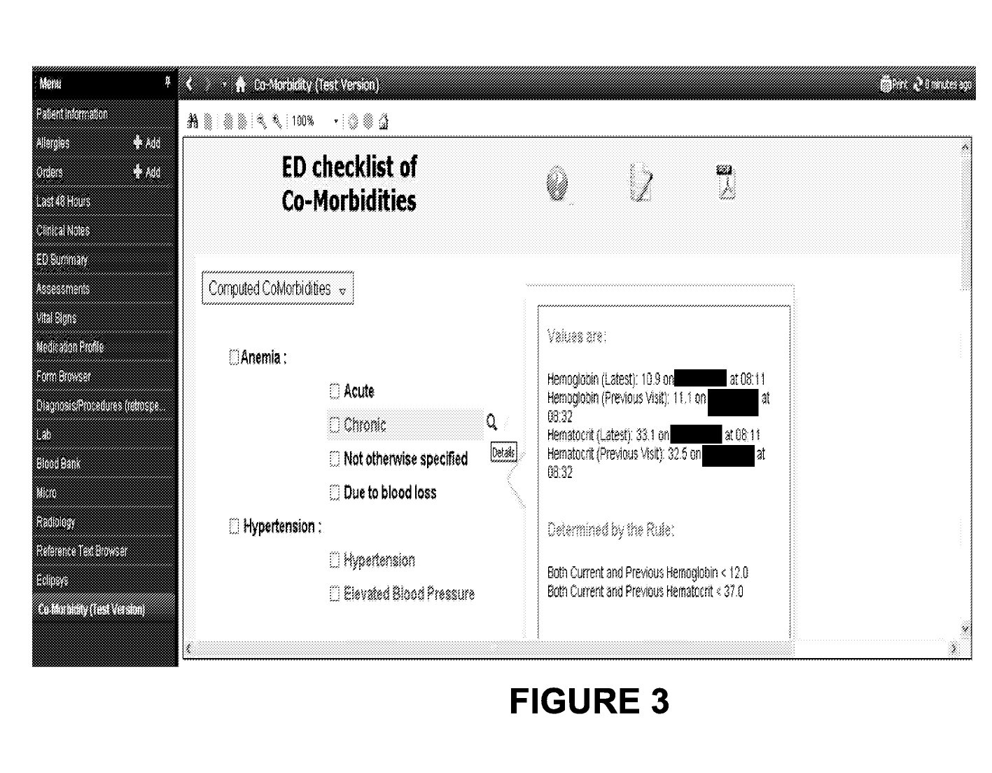

Upon completion of the analysis, the applicable co-morbidities, e.g., “co-morbidity-related clinical data”, are displayed in the ED checklist of Co-Morbidities, as shown in FIG. 3 which shows two co-morbidities: anemia and hypertension. In one embodiment, hovering over co-morbidity displays the associated lab value, the normal ranges and the corresponding rule morbidity, such as anemia—chronic shown in FIG. 3. As illustrated, the values for chronic anemia include the latest hemoglobin, a previous hemoglobin, the latest hematocrit and a previous hematocrit, all values including the date and time the value was measured. Also illustrated is the determination by the rule “Both Current and Previous Hemoglobin<12.0; Both Current and Previous Hematocrit<37.0”. Hence according to the rule, this patient has chronic anemia. The clinician reviews these values and clicks on the “square box” adjacent to the co-morbidity, e.g., chronic, if the determination made and displayed by the system is valid.

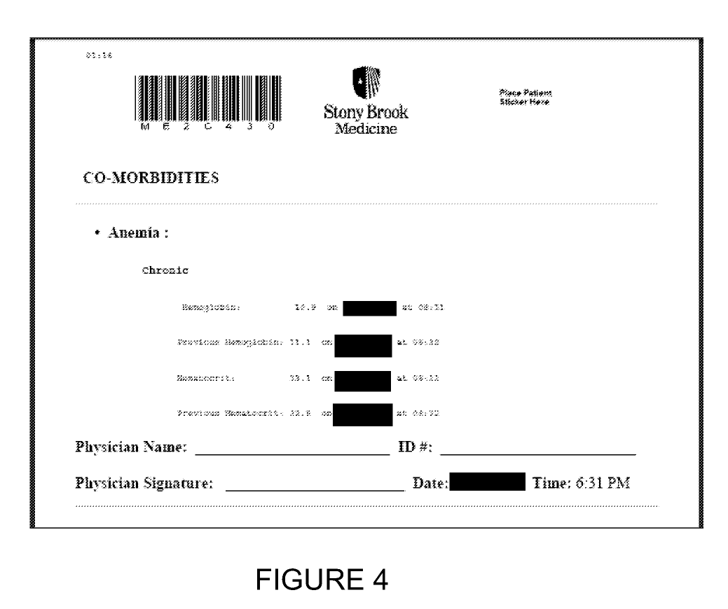

The physician can also choose to print the validation. FIG. 4 shows an exemplary print-out of validation of the chronic anemia finding determined in FIG. 3. The print-out shown in FIG. 4 can be signed, as validation, by the Physician and then placed in a patient's non-electric record and/or forwarded to the patient, his Primary, his insurance company and/or others.

In one embodiment, the current list of co-morbidities can include those based on non-lab test results. In particular, text-based Echo reports can be included to identify cardiac-related co-morbidities such as ejection fraction. In one embodiment, images can be associated with the reports. In one embodiment, the system can be interoperable across different Health IT systems.

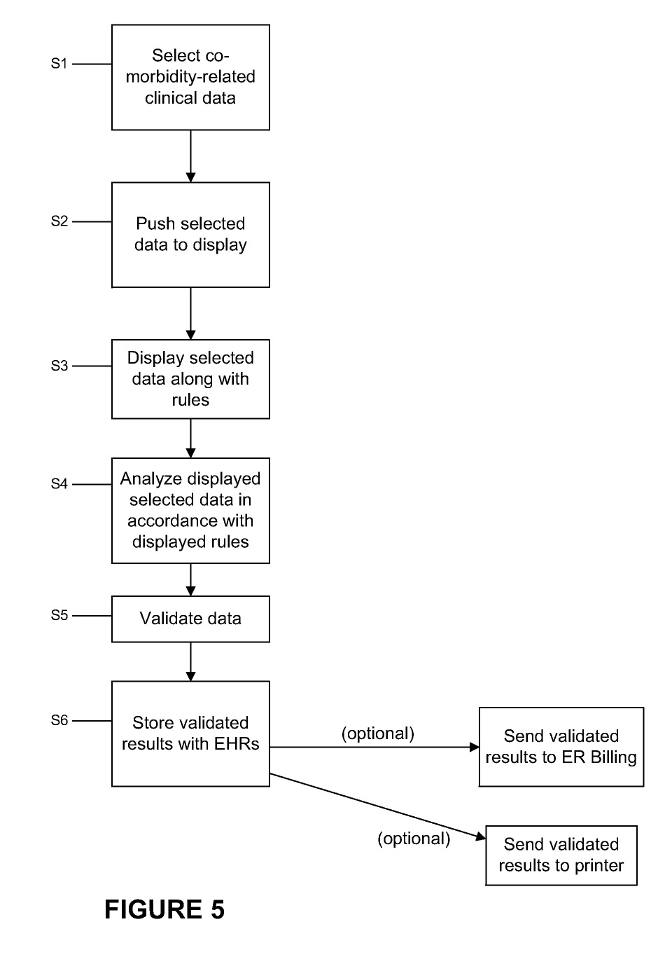

FIG. 5 is a flow diagram of the inventive method. In step S1, co-morbidity-related clinical data is selected in accordance with one or more rules. Clinical data can include data from laboratory tests, Radiology, EKG, Echo reports, etc. The data is selected based on analysis using Rule processor 24. In step S2, the selected clinical data is pushed to a display. In step S3, the selected clinical data is displayed, typically via a GUI 28, to the ER physician, along with the one or more rules. In step S4, the physician analyzes the displayed selected clinical data in accordance with the displayed rules. In step S5, acknowledgement or validation of the results is obtained from the ER physician. In step S6, validated results are stored in the EHR.

In one aspect, clinical data is obtained in the ER but other hospital and/or care center data can provide data, and the obtained data is processed, that is, the data is placed in a format for analysis. In one embodiment, NPL Analyzer 26 is used for formatting and/or processing the data.

In one aspect, billable actions performed in response to the validated results are forwarded for billing. In one aspect, validated results are printed.

The novel system and method can enhance work-flow in the emergency room, or other medical department or facility. The inventive method can be performed at multiple times including at time of emergency room (ED) disposition, such as during admission, during discharge from the emergency room, and/or during discharge from an inpatient facility. The method can be performed multiple times for a single patient, if appropriate. Each time the system is run and/or the method is performed, physician documentation supporting medical decision making is produced via interpretation of data and findings. This documentation can populate the patient's EHR.

More serious problems which are not the reason for a patient's visit to the emergency room may be classified as a secondary diagnosis. This is advantageous not only for the patient for treatment decisions, but also for the hospital facility, enabling it to capture billable actions and document medical decision-making.

Advantageously, the inventive system can bring orders of magnitude of efficiency improvements to an important ER process. In particular, the system can accrue significant savings in clinician's time and eliminate documentation errors and omissions. Further, by selecting the clinical data to be displayed and verified based on rules which are also displayed, information overload can be avoided.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for identifying and documenting co-morbidities, comprising:
a database server storing electronic health records;
an application server having a processor;
a user interface having at least a display; and
a module operable on the processor, said module operable to select co-morbidity-related clinical data in accordance with one or more rules, said clinical data selected for a patient from the history data of the patient, push the selected clinical data to the display, display the selected clinical data on the display along with the one or more rules, analyze the displayed selected clinical data in accordance with the displayed one or more rules, validate the displayed selected data, and store the validated data in the database server.

2. The system according to claim 1, wherein the module is further operable to send the validated data to billing.

3. The system according to claim 1, wherein the clinical data comprises one or more of historical data, laboratory data, EKG data, Echo data and radiology data.

4. The system according to claim 1, wherein a user selects the one or more rules.

5. The system according to claim 1, further comprising a printer, wherein the module is further operable to send the validated data to the printer.

6. A method for identifying and documenting co-morbidities, comprising steps of:
selecting co-morbidity-related clinical data in accordance with one or more rules, said clinical data selected for a patient from the history data of the patient;
pushing the selected clinical data to a display on a user interface;
displaying the selected clinical data on the display along with the one or more rules;
analyzing the displayed selected clinical data in accordance with the displayed one or more rules;
validating the displayed selected data; and
storing the validated data as part of a medical record.

7. The method according to claim 6, further comprising sending the validated data to billing.

8. The method according to claim 6, wherein the clinical data comprises one or more of historical data, laboratory data, EKG data, Echo data and radiology data.

9. The method according to claim 6, wherein a user selects the one or more rules.

10. The method according to claim 6, further comprising printing the validated data.

11. A computer readable storage device storing a program of instructions executable by a machine to perform a method for identifying and documenting co-morbidities, comprising:
selecting co-morbidity-related clinical data in accordance with one or more rules, said clinical data selected for a patient from the history data of the patient;
pushing the selected clinical data to a display on a user interface;
displaying the selected clinical data on the display along with the one or more rules;
analyzing the displayed selected clinical data in accordance with the displayed one or more rules;
validating the displayed selected data; and
storing the validated data as part of a medical record.

12. The program according to claim 11, further comprising sending the validated data to billing.

13. The program according to claim 11, wherein the clinical data comprises one or more of historical data, laboratory data, EKG data, Echo data and radiology data.

14. The program according to claim 11, wherein a user selects the one or more rules.

15. The program according to claim 11, further comprising printing the validated data.
